(19) United States
(12) Patent Application Publication
(10) Pub. No.: US 2006/0217268 A1
(43) Pub. Date: Sep. 28, 2006

(54) Method for protecting a system circuit from electrostatic discharge

(75) Inventor: Chin-Yuan Lin, Taichung City (TW)

Correspondence Address: BIRCH STEWART KOLASCH & BIRCH, PO BOX 747, FALLS CHURCH, VA, 22040-0747, US

(73) Assignee: A VISION INC.

(21) Appl. No.: 11/384,400

(22) Filed: Mar. 21, 2006

(30) Foreign Application Priority Data
Mar. 25, 2005 (TW) 94109318

(51) Int. Cl. C04B 35/45

(52) U.S. Cl. 505/126

(57) ABSTRACT

A method for protecting a system circuit from electrostatic discharge, switching the system operation state into an idle mode when displacement of a mechanical component takes place to set the state of the system chip to a non-operating state, and preventing the system chip from being damaged by static electric charge impact caused by external electrostatic discharge.

### BACKGROUND OF THE INVENTION

1. Field of Invention

The present invention relates to a method for protecting a system circuit from electrostatic discharge, in particular, to a method of switching the system operation state into idle mode owing to the activating mechanism to make the system chip remain in the non-operating state when displacement of a mechanical component takes place, and then prevent the electronic components from being damaged by external electrostatic discharge. The invention is applicable to a system or a device with a lid portion, such as a scanner, a printer, a photocopier, a fax machine, a Multi-Function Peripheral (MFP), and etc.

2. Related Art

Generally, an image processing device, such as a printer, includes electrical components (e.g., resistor, capacitor, etc.) and non-electrical components (such as toner cartridges, inkjet cartridges). In the event that electrostatic discharge (ESD) incident occurs at a high voltage, serious damage to electrical components could be likely to directly or indirectly cause thereto, as well as damage or destruction to internal non-electric components thereof. In other words, said damage may happen to both electrical components and non-electrical components of a system. Nowadays, a great number of printers includes their own ESD protection systems, respectively; however, the existing ESD protection structures are mostly designed to protect electrical components of the printers, such as the design of on-chip ESD protection circuits. For example, U.S. Pat. No. 5,717,560 and No. 5,910,874 disclose ESD protection circuits based on Gate Driven technology; in addition, U.S. Pat. No. 5,744,842 and U.S. Pat. No. 6,072,219 disclose ESD protection circuits based on Substrate-triggering technology. These inventions are the latest technologies to reduce the impact of electrostatic discharge on the electrical components. Nevertheless, there are still latent possibilities of having those non-electrical components damaged due to any ESD incidence. Even though the electrical components are designed to be protected from ESD, any ESD event would possibly causes damages to non-electrical components, in particular, those non-electrical components positioning adjacent to electrical components inside the system. U.S. Pat. No. 6,361,150 discloses an electrostatic discharge protection of non-electrical components in a thermal ink jet printer. The above-mentioned US patents mostly utilize the protection circuit design to solve ESD problems; currently, there is no any kind of technology that can simultaneously protect electrical components and non-electrical components of a system.

Generally, a conventional electrical system of a computer peripheral, such as a printer or a scanner, is designed to have a normal mode for activating the system, and in addition have at least a sleeping mode or a power saving mode; therefore, as long as the hardware system is not activated for a time period, the system would enter a power saving mode and the power supplying those electrical components that are not required in the hardware system is then cut down in order to save energy. Nevertheless, several data processing or data computing chips or Application-Specific Integration Circuits (ASIC) are designed to keep in a particular high or low activating state in connection with external interface when entering into either sleeping mode or power saving mode, in order to restore from sleeping mode or power saving mode back to normal operation mode of hardware system. Consequently, when an ASIC circuit of the hardware system in the normal mode encounters an mishandling of the machine, such as a paper jam in a printer, the act of opening the lid of the printer may easily draw the external electrostatic discharges into the internal electrical components resulting in the system crash or work safety problems, even a damage to the system chips due to the impact of electrostatic discharge.

Therefore, a method, which enables electrical components and non-electrical components of an electronic device or system to be protected at the same time in order to prevent the device or system from being damaged due to any ESD event, is required.

### SUMMARY OF THE INVENTION

In view of the foregoing drawbacks, the invention provides a method for protecting a system circuit from electrostatic discharge herein. Seeing that data processing or data computing chips, or an ASIC circuit of a system include a plurality of pins that include a reset pin, which sets said ASIC to either active mode or non-active mode, or either active high mode or active low mode. Usually, when the ASIC circuit is in the non-active mode or the active low mode, the system would be switched to an active state, where the electrical components of the system are more easier to be damaged by the electrostatic discharge; on the contrary, when the ASIC circuit is in a non-operation state, the system is not so easily being damaged by the electrostatic discharge.

Therefore, the object of the invention is to provide a system being capable of switching its operational mode according to its functionality. The system includes a casing, a detector module, disposed on the casing, for detecting that whether the electrical system is in a state for normal operation, wherein the detector module outputs a first signal when the detector module detects that the electrical system is not in the state for normal operation, and outputs a second signal when the detector module detects that the electrical system is in the state for normal operation, and a microprocessor, electrically connected to the detector module, for controlling the electrical system and for receiving the first signal and the second signal, wherein when the first signal is received, the microprocessor switches the electrical system into an idle mode, and when the second signal is received, the microprocessor switches the electrical system out of the idle mode. Therefore, the damage to of the electrical components, due to the static electric charges, is prevented. Consequently, the invention effectively protects the system from any system crash or halt, or industrial safety problems.

Another object of the present invention is to provide a method for protecting a system circuit from electrostatic discharge. The method includes at least the following steps

detecting whether a system is in an abnormal operation;

sending out a first signal;

switching the system to an idle mode according to the first signal;

detecting whether the system is in a state for normal operation;

sending out a second signal; and

switching the system out of the idle mode according to the second signal.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a systemic diagram of a method for protecting a system circuit from electrostatic discharge according to the invention;

FIG. 2 is a flow chart showing the execution of switching the system to an idle mode according to the invention;

FIG. 3 is a diagram showing the closing state of a lid of a device according to the invention; and

FIG. 4 is a diagram showing a device with a lid open according to the invention.

### DETAILED DESCRIPTION OF THE INVENTION

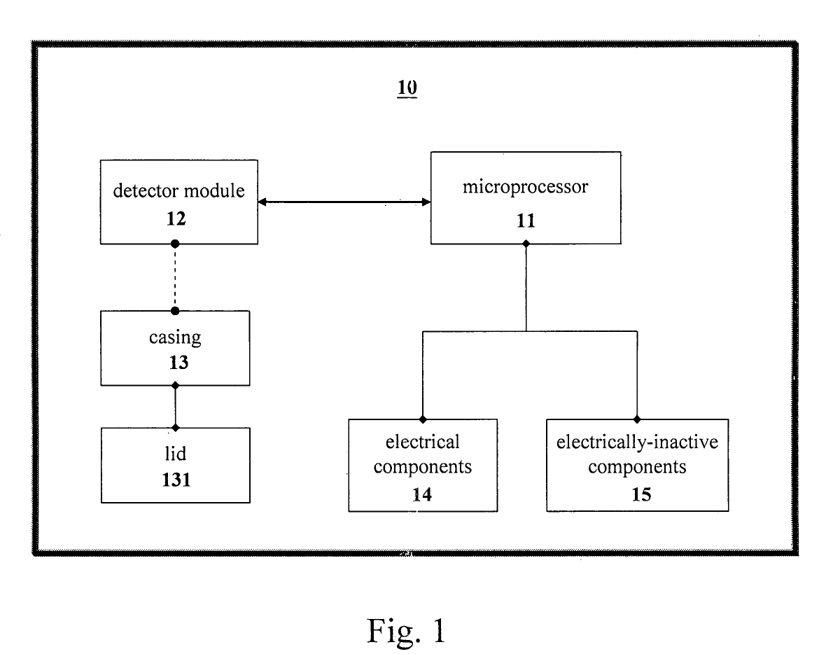

To enable a further understanding of the structural features and the technical contents of the invention, the brief description of the drawings is followed by the detailed description of embodiments. As shown in FIG. 1, the invention provides a method for protecting a system circuit from electrostatic discharge, wherein a system 10 includes at least a microprocessor 11, a detector module 12 and a casing 13 with a lid 131. The detector module 12, disposed on the casing 13, for detecting the operating state of the electrical system, wherein the detector module 12 outputs a first signal when the detector module 12 detects that the electrical system is in an abnormal operating state, and outputs a second signal when the detector module 12 detects that the electrical system is in a state of being able to normally operate; the microprocessor 11, electrically connected to the detector module 12, for controlling the electrical system and for receiving the first signal and the second signal, wherein when the first signal is received, the microprocessor 11 switches the electrical system into an idle mode, and when the second signal is received, the microprocessor 11 switches the electrical system out of the idle mode; the lid 131 is a part that can be designed in any form and installed on the casing 13 of the system 10 for a user to open or close. When detecting that the lid 131 is opened with respect to the casing 13, the detector module 12 sends out the first signal to the microprocessor 11, and when detecting that the lid 131 is closed, the detector module 12 sends out the second signal to the microprocessor 11.

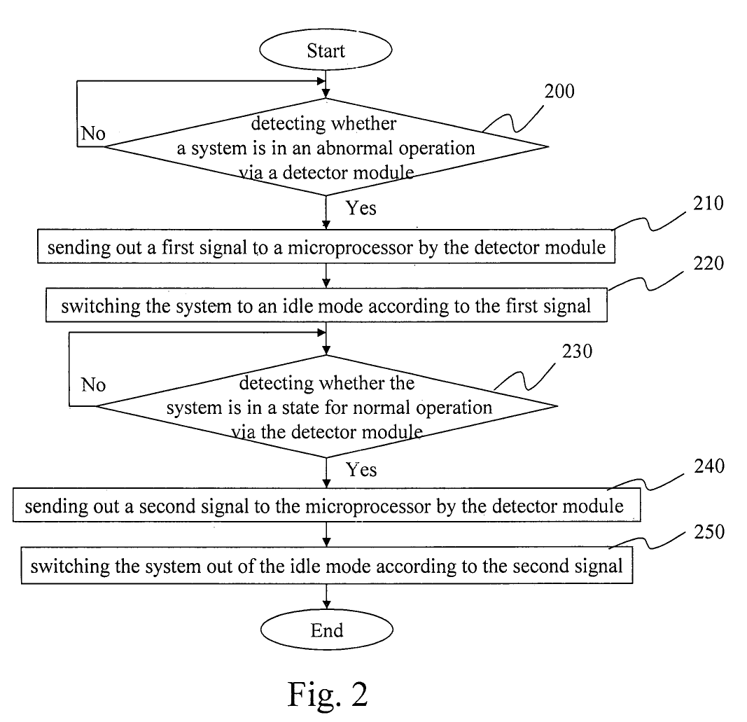

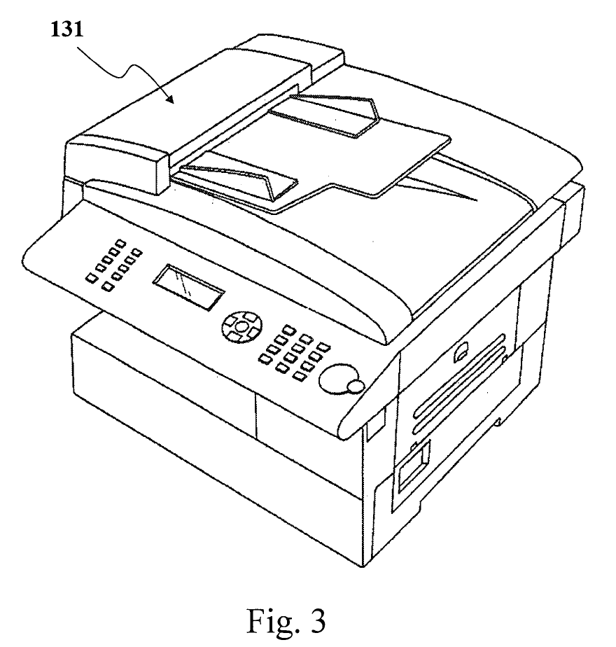

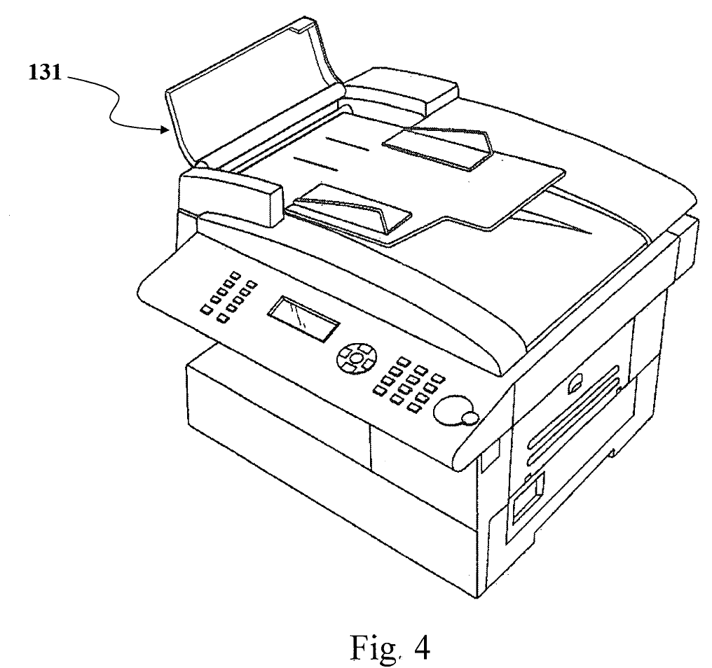

FIG. 2 is a flow chart showing the execution of switching the system to an idle mode according to the invention. In normal operation of an electrical device, such as a printer, a copier or a scanner, as shown in FIG. 3, the detector module 12 detects whether the system 10 is in an abnormal operation state (step 200). If the lid 131 of the device is opened by a user or by any external force, as shown in FIG. 4, subsequently, the detector module 12 sends out the first signal to the microprocessor 11 (step 210). When receiving the first signal, the microprocessor 11 switches the system to an idle mode (step 220), i.e., triggering a chip of the microprocessor 11 to enable the microprocessor 11 to be in a non-operation state, thereby preventing electrical components 14 and non-electrical components 15 of the system 10 from being damaged by the electrostatic discharge. When the system 10 is in the idle mode, the detector module 12 continuously detects if the system 10 is in a state for normal operation (step 230). If the event which causes the abnormal operation of the system 10 is removed, i.e., when the detector module 12 detects that the lid 131 is properly closed and the system 10 is in a state for normal operation as shown in FIG. 3, the detector module 12 sends out a second signal to the microprocessor 11 (step 240). When receiving the second signal, the microprocessor 11 then switches the system out of the idle mode (step 250), namely, triggering the chip of the microprocessor 11 to restore the microprocessor 11 back to the original active state, accepting a command from external interface and controlling the operation of the system 10, and thus, the system 10 is back to normal operation. Furthermore, an Application-Specific Integration Circuit (ASIC) can be used as the microprocessor 11. Therefore, the invention achieves the objective of effectively preventing the system 10 from the crash down or protecting the system 10 from safety problems.

New characteristics and advantages of the invention covered by this document have been set forth in the foregoing description. It is of course to be understood however, that this disclosure is, in many respects, only illustrative. Changes may be made in details without exceeding the scope of the invention by those who are skilled in the art under the doctrine of equivalents. The scope of the invention is, of course, defined in the language in which the appended claims are expressed.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for protecting a system circuit from electrostatic discharge, comprising the following steps:
detecting whether a system is in an abnormal operating state;
sending out a first signal;
switching the system to an idle mode according to the first signal;
detecting whether the system is in a state for normal operation;
sending out a second signal; and
switching the system out of the idle mode according to the second signal.

2. An electrical system comprising:
a casing;
a detector module, disposed on the casing, for detecting whether the electrical system is in an abnormal operation state, wherein the detector module outputs a first signal when the detector module detects that the electrical system is in the abnormal operation state, and outputs a second signal when the detector module detects that the electrical system is in the state for normal operation; and
a microprocessor, electrically connected to the detector module, for controlling the electrical system and for receiving the first signal and the second signal, wherein when the first signal is received, the microprocessor switches the electrical system into an idle mode, and when the second signal is received, the microprocessor switches the electrical system out of the idle mode.

3. The electrical system of claim 2, wherein the detector module detects whether a lid installed on the casing is opened or closed, and sends out either the first signal when the detector module detects that the lid is opened or the second signal when the detector module detects that the lid is closed to the microprocessor.

4. The electrical system of claim 2, wherein the microprocessor is an Application-Specific Integration Circuit (ASIC).

5. The electrical system of claim 2, wherein the state for abnormal operation is that the lid installed on the casing is open with respect to the casing.

6. The electrical system of claim 2, wherein the idle mode is the state when the chip of the microprocessor is triggered to enable the microprocessor to enter a non-operation state.

7. The electrical system of claim 2, wherein the first signal triggers the microprocessor to switch the system into the idle mode.

8. The electrical system of claim 2, wherein the second signal triggers the microprocessor to switch the system out of the idle mode.
